(19) United States
(12) Patent Application Publication
(10) Pub. No.: US 2026/0353026 A1
(43) Pub. Date: Nov. 5, 2026

(54) GENERATING REVERBERATION FOR CONNECTED SPACES IN AN EXTENDED REALITY SCENE

(71) Applicant: Telefonaktiebolaget LM Ericsson (publ), Stockholm (SE)

(72) Inventor: Werner DE BRUIJN, Utrecht (NL)

(73) Assignee: Telefonaktiebolaget LM Ericsson (publ), Stockholm (SE)

(21) Appl. No.: 19/491,121

(22) PCT Filed: Jun. 7, 2024
(86) PCT No.: PCT/EP2024/065803

§ 371 Date: Dec. 8, 2025

Related U.S. Application Data
(60) Provisional application No. 63/472,104, filed on Jun. 9, 2023.

(51) Int. Cl. H04S 7/00

(52) U.S. Cl. CPC H04S 7/305; H04S 7/302; H04S 2400/11

(57) ABSTRACT

There is provided a method for enabling the rendering of reverberation in an extended reality (XR) scene. The method comprises, based on whether a listener is in a first space of the XR scene or not, determining a value of a reverberation related parameter (RRP) for generating reverberation for the first space. The method further comprises, using the value of the RRP, configuring a reverberation algorithm for generating reverberation for the first space.

### TECHNICAL FIELD

This disclosure relates to generating reverberation for connected spaces in an extended reality scene.

### BACKGROUND

Extended reality (XR) (e.g., virtual reality (VR), augmented reality (AR), mixed reality (MR), etc.) systems generally include an audio renderer for rendering audio to the user of the XR system. The audio renderer typically contains a reverberation processor (a.k.a., “reverberator”) for generating late and/or diffuse reverberation that is rendered to the user of the XR system to provide an auditory sensation of being in the XR scene that is being rendered. The generated reverberation should provide the user with the auditory sensation of being in the acoustic environment (AE) (a.k.a., “space”) corresponding to the XR scene (e.g., a living room, a gym, an outdoor environment, etc.).

Reverberation is one of the most significant acoustic properties of a space. Sound produced in a room will repeatedly bounce off reflective surfaces such as the floor, walls, ceiling, windows or tables while gradually losing energy. When these reflections mix with each other, the phenomena known as “reverberation” is created. Reverberation is thus a collection of many reflections of sound.

Two of the most fundamental characteristics of the reverberation in any space, real or virtual, are: 1) the reverberation time and 2) the reverberation level, i.e., how strong or loud the reverberation is (e.g., relative to the power or direct sound level of sound sources in the space).

The reverberation time is a measure of the time required for reflected sound to “fade away” in an enclosed space after the source of the sound (“sound source”) has stopped. It is important in defining how a room will respond to acoustic sound. Reverberation time depends on the amount of acoustic absorption in the space, being lower in spaces that have many absorbent surfaces such as curtains, padded chairs or even people, and higher in spaces containing mostly hard, reflective surfaces. Conventionally, the reverberation time is defined as the amount of time the sound pressure level takes to decrease by 60 dB after a sound source is abruptly switched off. The shorthand for this amount of time is “RT60” (or, sometimes, T60).

Typically, for a reverberator used in an audio renderer, these two (and other) characteristics of generated reverberation may be controlled individually and independently. For example, it is typically possible to configure the reverberator to generate reverberation with a certain desired reverberation time and a certain desired reverberation level.

In an XR system, the characteristics of the generated reverberation are typically controlled by control information, e.g., special metadata contained in the XR scene description, e.g., as specified by the scene creator, which describes many aspects of the XR scene including its acoustical characteristics. The audio renderer receives this control information, e.g., from a bitstream or a file, and uses this control information to configure the reverberator to produce reverberation with the desired characteristics. The exact way in which the reverberator obtains the desired reverberation time and reverberation level in the generated reverberation may differ, depending on the type of reverberation algorithm that the reverberator uses to generate reverberation.

As indicated above, one of the key aspects of immersive rendering of audio is the realistic rendering of reverberation associated with the virtual space of the XR scene. A special challenge is the realistic rendering of reverberation in spaces that are connected (or “coupled”) to another space via a “portal” (e.g., open door, open window, partly transmissive window, partly transmissive wall, etc.)—i.e., anything through which sounds from one space can propagate to the connected space (and vice versa). A common technical solution for generating high-quality, configurable reverberation in an XR (e.g., VR, AR, MR, etc.) audio system is a so-called Feedback Delay Network (FDN).

An example of an FDN is shown in FIG. 1 disclosed in Reference [2]. In FIG. 1, the FDN comprises a number (D) of recirculating delay lines (a.k.a., “loops”) which are mixed with each other via a feedback matrix A to create an increasingly diffuse late reverberation signal at each of the D outputs of the FDN.

The computational complexity of an FDN is determined for a large part by the number of delay lines used. At the same time, there is a strong relationship between the number of delay lines of the FDN and the quality of the generated reverberation in terms of temporal density/smoothness of the resulting reverberation impulse response, where a larger number of delay lines results in a denser, smoother (both temporally and spectrally) impulse response.

Hence, there is a trade-off between computational complexity and quality when choosing the number of delay lines of an FDN, and in many applications, it is desirable to be able to control this trade-off by adjusting the number of delay lines. Therefore, allowing to adjust this quality-computational complexity trade-off by enabling adjusting the number of delay lines is a common feature in many FDN-type reverberation implementations.

### SUMMARY

Certain challenges presently exist. For example, in multi-room XR (e.g., AR, VR, or MR) scenes that comprise many connected spaces in which reverberation is generated simultaneously (with an individual FDN for each space), achieving a good quality-computational complexity trade-off is especially challenging. If the reverberation for all the connected spaces is generated with a high quality (i.e., with a high number of FDN delay lines), this may result in an excessive total computational complexity for the reverberation processing.

To address this issue, the number of FDN delay lines for each AE (i.e., space) in the multi-room scene may be set depending on the acoustic properties of that AE (e.g., the AE's reverberation time) and the number of AEs in the scene. For AEs with short reverberation times and/or for scenes with many connected AEs, FDNs can be configured with smaller numbers of delay lines, whereas FDNs for AEs with particularly demanding acoustics (e.g., AEs with long reverberation times) and/or for scenes with only a small number of connected AEs can be configured with a higher number of delay lines so as to maximize the quality of the reverberation.

But configuring the quality of reverberation (e.g., configuring a certain number of FDN delay lines for reverberation rendering) in an AE solely based on the acoustic properties of the AE and/or the number of AE's in the scene may still result in a high and potentially excessive computational complexity in multi-room scenes in case the scenes comprise a large number of connected AEs and/or all or many of the connected AEs have acoustical properties (e.g., reverberation times) that require a high-quality of reverberation. Therefore, there is a need for a method and/or an apparatus for efficiently setting the quality of reverberation for multiple AEs in a multi-room XR environment.

Accordingly, in one aspect of some embodiments of this disclosure, there is provided a method for enabling the rendering of reverberation in an extended reality, XR, scene. The method comprises, based on whether a virtual listener is in a first space of the XR scene or not, determining a value of a reverberation related parameter, RRP, for generating reverberation associated with the first space. The method further comprises, using the value of the RRP, configuring a reverberation algorithm for generating reverberation associated with the first space.

In another aspect, there is provided a method for enabling the rendering of reverberation in an extended reality, XR, scene. The method comprises determining that a virtual listener is in a first space of the XR scene, after determining that the virtual listener is in the first space of the XR scene, determining an effective distance between the first space and a second space, and comparing the effective distance to a predefined distance. The method further comprises, based on the comparison, determining that the effective distance is greater than the predefined distance, and based on determining that the effective distance is greater than the predefined distance, setting a value of a reverberation related parameter, RRP, to a first value and/or determining to not generate any reverberation associated with the second space, wherein the RRP is for generating reverberation associated with the second space.

In a different aspect, there is provided a computer program comprising instructions which when executed by processing circuitry cause the processing circuitry to perform the method of any one of the above embodiments.

In a different aspect, there is provided a carrier containing the computer program of the above embodiments, wherein the carrier is one of an electronic signal, an optical signal, a radio signal, and a computer readable storage medium.

In a different aspect, there is provided an apparatus for enabling the rendering of reverberation in an extended reality, XR, scene. The apparatus is configured to: based on whether a virtual listener is in a first space of the XR scene or not, determine a value of a reverberation related parameter, RRP, for generating reverberation associated with the first space; and using the value of the RRP, configure a reverberation algorithm for generating reverberation associated with the first space.

In a different aspect, there is provided an apparatus for enabling the rendering of reverberation in an extended reality, XR, scene. The apparatus is configured to determine that a virtual listener is in a first space of the XR scene, and after determining that the virtual listener is in the first space of the XR scene, determine an effective distance between the first space and a second space. The apparatus is further configured to compare the effective distance to a predefined distance, and based on the comparison, determine that the effective distance is greater than the predefined distance. The apparatus is further configured to, based on determining that the effective distance is greater than the predefined distance, set a value of a reverberation related parameter, RRP, to a first value and/or determine to not generate any reverberation associated with the second space, wherein the RRP is for generating reverberation associated with the second space.

In a different aspect, there is provided an apparatus comprising: a processing circuitry; and a memory, said memory containing instructions executable by said processing circuitry, whereby the apparatus is operative to perform the method of at least one of the above embodiments.

Some embodiments of this disclosure allow optimizing the trade-off between computational complexity and subjective quality of reverberation generated for multiple individual spaces in a multi-space XR environment.

### BRIEF DESCRIPTION OF THE DRAWINGS

The accompanying drawings, which are incorporated herein and form part of the specification, illustrate various embodiments.

FIG. 1 shows an example of a feedback delay network.

FIG. 2A shows a system according to some embodiments.

FIG. 2B shows a system according to some embodiments.

FIG. 3 illustrates a system according to some embodiments.

FIG. 4A shows audio rendering in an XR environment.

FIG. 4B shows audio rendering in an XR environment.

FIG. 5 shows an exemplary multi-room XR scene.

FIG. 6 shows a process according to some embodiments.

FIG. 7 shows an apparatus according to some embodiments.

FIG. 8 shows a process according to some embodiments.

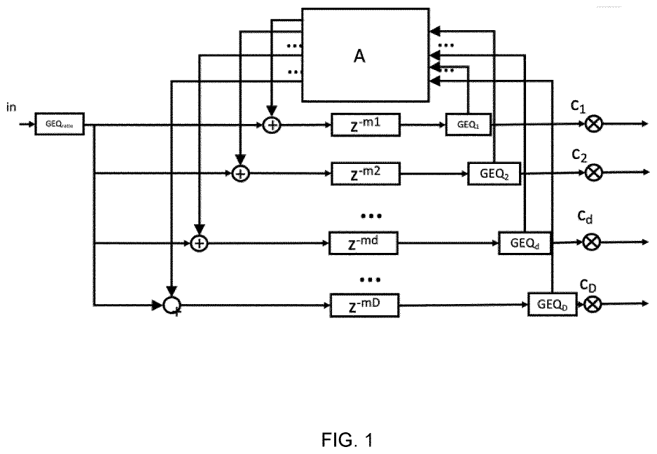

### DETAILED DESCRIPTION

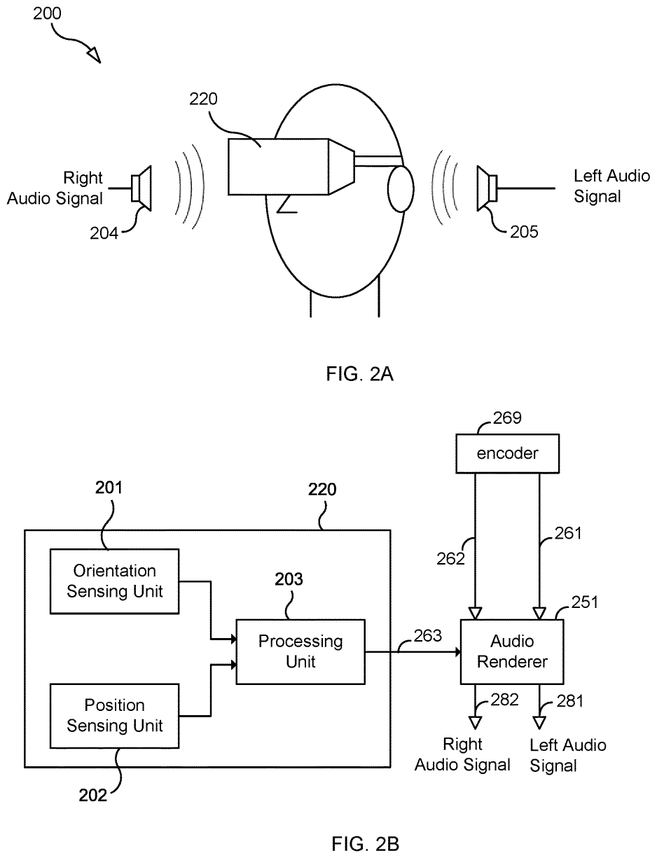

FIG. 2A illustrates an XR system 200 in which the embodiments disclosed herein may be applied. XR system 200 includes speakers 204 and 205 (which may be speakers of headphones worn by the user) and an XR device 220 that may include a display for displaying images to the user and that, in some embodiments, is configured to be worn by the listener. In the illustrated XR system 200, XR device 220 has a display and is designed to be worn on the user's head and is commonly referred to as a head-mounted display (HMD).

As shown in FIG. 2B, XR device 220 may comprise an orientation sensing unit 201, a position sensing unit 202, and a processing unit 203 coupled (directly or indirectly) to an audio render 251 for producing output audio signals (e.g., a left audio signal 281 for a left speaker and a right audio signal 282 for a right speaker as shown) using input audio signals (e.g., encoded audio data) 261 and metadata 262, which, in this example, is shown as being provided by an encoder 269. For example, encoder 269 may generate a bitstream containing the encoded audio data 261 and metadata 262.

Orientation sensing unit 201 is configured to detect a change in the orientation of the listener and provides information regarding the detected change to processing unit 203. In some embodiments, processing unit 203 determines the absolute orientation (in relation to some coordinate system) given the detected change in orientation detected by orientation sensing unit 201. There could also be different systems for determination of orientation and position, e.g., a system using lighthouse trackers (LIDAR). In one embodiment, orientation sensing unit 201 may determine the absolute orientation (in relation to some coordinate system) given the detected change in orientation. In this case the processing unit 203 may simply multiplex the absolute orientation data from orientation sensing unit 201 and positional data from position sensing unit 202. In some embodiments, orientation sensing unit 201 may comprise one or more accelerometers and/or one or more gyroscopes.

Audio renderer 251 produces the audio output signals based on input audio signals 261, metadata 262 regarding the XR scene the listener is experiencing, and information 263 about the location and orientation of the listener. The metadata 262 for the XR scene may include metadata for each object and audio element included in the XR scene, as well as metadata for the XR space (“acoustic environment”) in which the listener is virtually located. The metadata for an object may include information about the dimensions of the object and occlusion factors for the object (e.g., the metadata may specify a set of occlusion factors where each occlusion factor is applicable for a different frequency or frequency range). The metadata 262 may also include control parameters, such as a reverberation time value, a reverberation level value, and/or absorption parameter(s).

Audio renderer 251 may be a component of XR device 220 or it may be remote from the XR device 220 (e.g., audio renderer 251, or components thereof, may be implemented in the cloud).

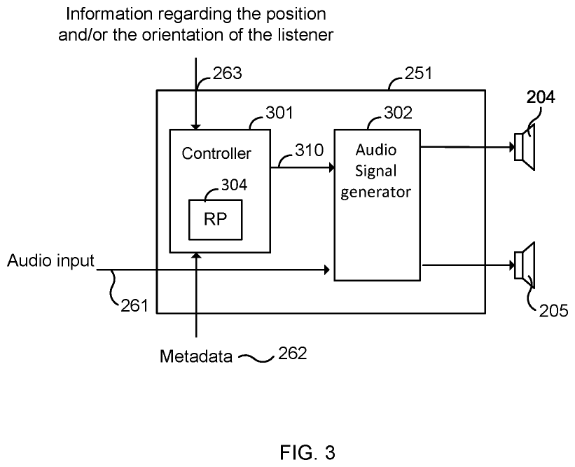

FIG. 3 shows an example implementation of audio renderer 251 for producing sound for the XR scene. Audio renderer 251 includes a controller 301 and an audio signal generator 302 for generating the output audio signal(s) (e.g., the audio signals of a multi-channel audio element) based on control information 310 from controller 301 and input audio 261. In some embodiments, controller 301 may comprise a reverberation processor (RP) 304. In other embodiments, the audio signal generator 302 may comprise RP 304.

In some embodiments, controller 301 may be configured to receive one or more parameters and to trigger audio signal generator 302 to perform modifications on audio signals 261 based on the received parameters (e.g., increasing or decreasing the volume level). The received parameters include information 263 regarding the position and/or orientation of the listener (e.g., direction and distance to an audio element), and metadata 262 regarding the XR scene. As noted above, metadata 262 may include metadata regarding the XR space in which the user is virtually located (e.g., dimensions of the space, information about objects in the space and information about acoustical properties of the space) as well as metadata regarding audio elements and metadata regarding an object occluding an audio element. In some embodiments, controller 301 itself produces at least a portion of the metadata 262. For instance, controller 301 may receive metadata about the XR scene and derive additional metadata (e.g., control parameters) based on the received metadata. For instance, using the metadata 262 and position/orientation information 263, controller 301 may calculate one or more gain factors (g) for an audio element in the XR scene.

With respect to the generation of a reverberation signal that is used by signal generator 302 to produce the final output signals, controller 301 provides to signal generator 302 reverberation parameters, such as, for example, reverberation time and reverberation level for a space in the XR scene, so that signal generator 302 is operable to generate the reverberation signal. The reverberation time for the generated reverberation is most commonly provided to the reverberation processor 304 as an RT60 value, typically for individual frequency bands, although other reverberation time measures exist and can be used as well. In typical embodiments, the metadata 262 includes all of the necessary reverberation parameters (e.g., RT60 values and reverberation level values). But in embodiments in which the metadata does not include all necessary reverberation parameters, controller 301 may be configured to generate the missing parameters.

The reverberation level may be expressed in various formats. Typically, it will be expressed as a relative level. For example, it may be expressed as an energy ratio between direct sound and reverberant sound components (DRR) or it's inverse (i.e., the RDR energy ratio) at a certain distance from a sound source that is rendered in the XR environment. Alternatively, the reverberation level may be expressed in terms of an energy ratio between reverberant sound and total emitted energy or power of a source. In yet other cases, the reverberation level may be expressed directly as a level/gain for the reverberation processor.

In this context, the term “reverberant” may typically refer to only those sound field components that correspond to the diffuse part of the acoustical room impulse response of the acoustic environment, but in some embodiments it may also include sound field components corresponding to earlier parts of the room impulse response, e.g., including some late non-diffuse reflections, or even all reflected sound.

Other metadata describing reverberation-related characteristics of the acoustical environment that may be included in the metadata 262 include parameters describing acoustic properties of the materials of the environment's surfaces (describing, e.g., absorption, reflection, transmission and/or diffusion properties of the materials), or specific time points of the room impulse response associated with the acoustical environment, e.g. the time after the source emission after which the room impulse response becomes diffuse (sometimes called “pre-delay”) and/or rendering of generated reverberation starts.

All reverberation-related properties described above are typically frequency-dependent, and therefore their related metadata parameters are typically also provided and processed separately for a number of frequency bands.

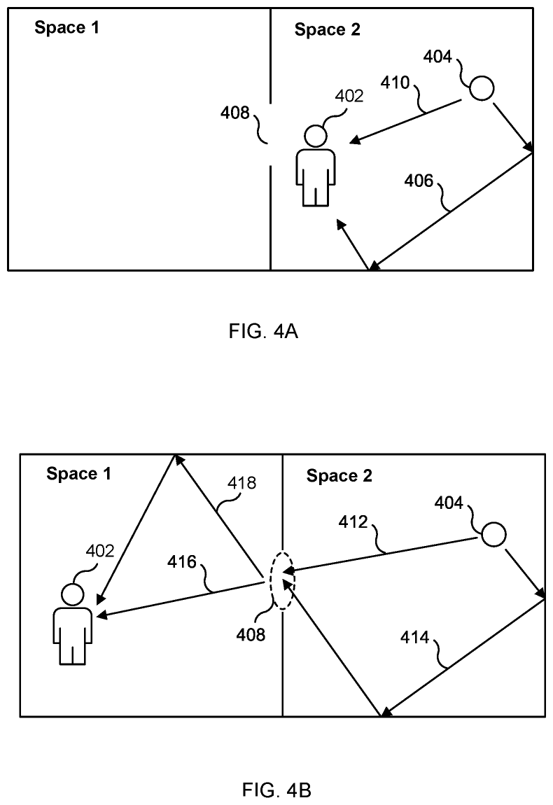

As explained above, in order to achieve the realistic rendering of reverberation in a multi-room XR environment, the number of FDN delay lines, which controls the quality of reverberation generated for a space, may be determined based on the acoustic properties (e.g., the reverberation time, the reverberation level, the reverberation energy ratio, etc.) of the space. However, determining the number of FDN delay lines solely based on the acoustic properties of a space may not result in an efficient rendering of reverberation (i.e., may not result in a well-balanced trade-off between computational complexity and quality of reverberation). FIGS. 4A and 4B illustrate this problem.

FIG. 4A shows an exemplary scenario of a virtual environment that comprises Space 1 and Space 2 that is connected to the Space 1 via a portal 408. As explained above, in this disclosure, a “portal” is defined as any interface connecting a first space to a second space (e.g., an opening or a (partly) transmissive surface) through which sound from the first space can propagate to the second space (and vice versa). In the Space 2, there is a virtual user 402 which is controlled by the user of the XR system 200 shown in FIG. 2A. As the user of the XR system 200 controls the virtual user 402 to navigate within the virtual environment, audio corresponding to the virtual environment is rendered to the user of the XR system 200 via the speakers 204 and 205. In FIG. 4A, the audio rendered to the user of the XR system 200 comprises a direct part 410 of the audio generated by an audio source 404 and a reverberation part 406 of the audio generated by the audio source 404, i.e., rendered audioₜₒₜₐₗ=direct₄₁₀ of audio₄₀₄+reverberation₄₀₆ of audio₄₀₄.

FIG. 4B shows a different exemplary scenario of the virtual environment. As compared to the scenario shown in FIG. 4A, in FIG. 4B, the virtual user 402 is in the Space 1. In FIG. 4B, the audio rendered to the user of the XR system 200 comprises a direct part 416, which consists of the part of the audio that propagates through the portal 408 from the Space 2 that reaches the virtual user 402 directly from the portal, and a reverberation part 418, which consists of the part of the audio that propagates through the portal 408 from the Space 2 that reaches the virtual user 402 indirectly through reflections in Space 1. The audio that propagates through the portal 408 from the Space 2 comprises a direct part 412 of the audio generated by the audio source 404 and a reverberation part 414 of the audio generated by the audio source 404, i.e., rendered audioₜₒₜₐₗ=direct₄₁₆ of audio_{at portal}+reverberation₄₁₈ of audio_{at portal}, where audio_{at portal}=direct₄₁₂ of audio₄₀₄+reverberation₄₁₄ of audio₄₀₄.

As indicated above, the contribution of the reverberation part (414) of the audio for the Space 2 to the overall audio rendered to the user in the scenario shown in FIG. 4B is not as high as the contribution of the reverberation part (406) of the audio in the Space 2 to the overall audio rendered to the user in FIG. 4A. This is because, in FIG. 4A, the space for which the reverberation part 406 is generated (i.e., Space 2) is the same as the listener's space while, in FIG. 4B, the space for which the reverberation part 414 is generated (i.e., Space 2) is different from the listener's space (i.e., Space 1) and only a part of the generated reverberation part 414 reaches the listener's space. Thus, the quality of the reverberation generated for the Space 2 (e.g., the reverberation part 414) in the scenario shown in FIG. 4B is not as critical as the quality of the reverberation generated for the Space 2 (e.g., the reverberation part 406) in the scenario shown in FIG. 4A. Therefore, generating the reverberation for a space at the same quality regardless of whether the virtual user is in the same space would not result in a balanced trade-off between computational complexity and quality of reverberation.

Accordingly, in some embodiments of this disclosure, the quality of reverberation generated for a certain space in a multi-space XR scene is determined based at least on whether the virtual user is in the same space or in a different space (e.g., a space that is connected to the certain space). The quality of reverberation generated for a space may be determined by determining value(s) of one or more parameters that affect the quality of the reverberation, and such parameter is called a “reverberation related parameter” (a.k.a., “RRP”) in this disclosure. The RRP may be a control parameter of a reverberation algorithm and/or may be related to one or more certain design features of the reverberation algorithm. One example of the RRP is the number of delay lines for an FDN in case the FDN is used for generating reverberation for a space.

For simple explanation purpose, the embodiments below are explained using the number of FDN delay lines as an example of the RRP. But the embodiments are equally applicable to other types of the RRP such as length of delay lines, the sampling rate used by the reverberator, number of frequency bands of the reverberator, complexity of filters included in the reverberator, etc. and/or other types of reverberation algorithms such as convolution-based reverberators, digital waveguide reverberators, etc. Therefore, wherever the description below discloses setting, controlling, adjusting, choosing, determining, generating, selecting, or choosing the number of delay lines of an FDN, it may also be read more generally as setting, controlling, adjusting, choosing, determining, generating, selecting, or choosing the complexity of a reverberation algorithm, the quality of the reverberation generated by the reverberation algorithm, a control parameter that controls the complexity and/or quality of reverberation, and/or a trade-off between computational complexity and quality of reverberation.

### Distinction Between Listener's AE and Connected AEs

In some embodiments, when choosing the number of delay lines of an FDN used for generating reverberation for an AE, only a distinction is made between an AE where the virtual user is in (a.k.a., “listener's AE) and other AEs that are connected to the listener's AE (a.k.a., “connected AEs”).

In these embodiments, reverberation of “nominal” quality/complexity (e.g., as determined according to the general or specific criteria described in Reference [1], i.e., from the AE's acoustic properties, or as specified in a control parameter that may be specific for the AE or may be a general control parameter that applies to all AEs) may only be generated for the listener's AE, while for all other connected AEs, reverberation of a lower quality/complexity may be generated (either lower than the reverberation quality/complexity of the listener's AE, or lower than the nominal reverberation qualities/complexities for the connected AE's according to the criteria described in [1] or as specified in control parameters for the connected AE's).

For example, in case of an FDN reverberator, the number of delay lines of the FDN for the listener AE may be chosen according to the general or specific criteria described in Reference [1], i.e., based on the listener AE's acoustic properties or as specified in a control parameter for the listener's AE, while the FDN for each connected AE may be configured with a number of delay lines that is smaller than the number of delay lines according to the general or specific criteria described in Reference [1], i.e., based on the connected AE's acoustic properties or as specified in a control parameter for the connected AE. So, in these embodiments, the number of delay lines of an FDN (or more generally: the quality/complexity of generated reverberation) associated with an AE is determined based on whether the listener is located in that specific AE or not.

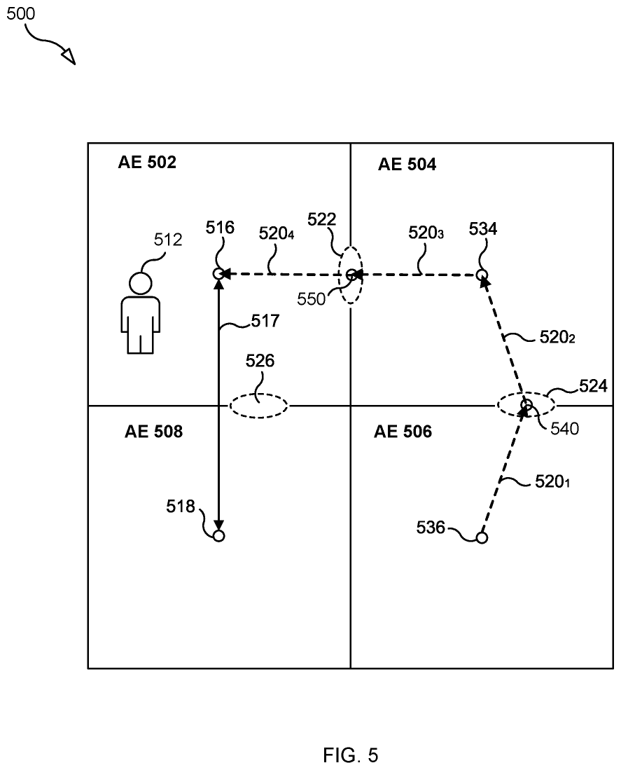

FIG. 5 shows an exemplary XR environment 500 where the embodiments above can be applied. The XR environment 500 includes a first AE 502, a second AE 504, a third AE 506, and a fourth AE 508. The virtual user 512 is in the first AE 502, and the second, third, and fourth AEs 504-508 are connected to the first AE 502 via portals 522, 524, and 526.

To generate audio for the XR environment 500, the XR system may first obtain a nominal number of FDN delay lines (i.e., N₅₀₂, N₅₀₄, N₅₀₆, N₅₀₈) for each of the first, second, third, and fourth AEs 502, 504, 506, and 508. N₅₀₂, N₅₀₄, N₅₀₆, and N₅₀₈ may be the same or different.

The nominal numbers of FDN delay lines for the first through fourth AEs 502, 504, 506, and 508 may be obtained by receiving a bitstream that indicates such nominal numbers (or a single such nominal number that is applicable to all AEs) or may be generated based on the acoustic properties of the AEs 502, 504, 506, and 508. More specifically, in some embodiments, the nominal number of FDN delay lines used for generating reverberation for an AE may be generated based on one or more of the acoustic properties of the AE. For example, the nominal number of FDN delay lines for an AE may be determined using a table that provides a mapping between a specific one of preset values and a combination of one or more acoustic properties. Examples of such acoustic properties of an AE include a reverberation time, a reverberation level, a reverberation energy ratio (e.g., a direct-to-reverberant ratio or any other similar ratio), etc. In some embodiments, the acoustic properties of an AE may be provided in metadata for the AE.

In these embodiments, the XR system may determine which one of the AEs the virtual user is in. After determining that the virtual user is in the AE 502, the XR system may use the nominal number of FDN delay lines (N₅₀₂) as it is for generating reverberation for the listener's AE (i.e., the AE 502) but may adjust the nominal numbers of FDN delay lines (i.e., N₅₀₄, N₅₀₆, N₅₀₈) in one or more other AEs (i.e., one or more of the AEs 504, 506, and 508) for generating reverberation for the other AEs. In one example, for one or more of the AEs 504, 506, and 508, the XR system may derive new numbers of FDN delay lines based on the nominal numbers of FDN delay lines, which are given to the AEs 504, 506, and 508. Here, if each of the nominal numbers of FDN delay lines (i.e., N₅₀₄, N₅₀₆, N₅₀₈) for each of the connected AEs 504, 506, and 508 is for generating reverberation for each AE in case the AE is the listener's AE, the nominal numbers of FDN delay lines for each of the connected AEs 504, 506, and 508 can be adjusted by reducing the nominal numbers (as the AEs 504, 506, and 508 are the connected AEs, not the listener's AE, in FIG. 5). In other words, each of the adjusted nominal numbers

$$( i . e . , {N}_{504}^{′} , {N}_{506}^{′} , {N}_{508}^{′} )$$

of FDN delay lines for the AEs 504, 506, and 508 should be equal or less than each of the original numbers (i.e., N₅₀₄, N₅₀₆, and N₅₀₈) of FDN delay lines for the AE 502. In other words, the new numbers of FDN delay lines

$${N}_{504}^{′} , {N}_{506}^{′} , {N}_{508}^{′}$$

may be derived based on the nominal numbers N₅₀₄, N₅₀₆, N₅₀₈ where

$${N}_{504}^{′} \leq {N}_{504} , {N}_{506}^{′} \leq {N}_{506} , {N}_{508}^{′} \leq {N}_{508} .$$

Alternatively, after determining that the virtual user is in the AE 502, the XR system may adjust the nominal number of FDN delay lines (N₅₀₂) for generating reverberation for the AE 502 by a first amount but may adjust the nominal numbers of FDN delay lines (i.e., N₅₀₄, N₅₀₆, N₅₀₈) for generating reverberation for the AEs 504, 506, and 508 by a second amount. Here, the first amount is less than the second amount as the AE 502 is the listener's AE while the AEs 504, 506, and 508 are connected AEs.

### Effective Distances Between AEs

In some embodiments, the number of delay lines of an FDN (or more generally, the quality/complexity of generated reverberation, as discussed above) for generating reverberation for an AE depends on the relationship of that AE to the listener's AE. More specifically, in these embodiments, the number of FDN delay lines used for generating reverberation for an AE may be determined based on an effective distance between that AE and the listener's AE. For example, in an implementation based on FDN reverberators, the “further” away a connected AE is from the listener's AE, the smaller the number of delay lines of the corresponding FDN may be used for generating reverberation for the AE.

The effective distance between two AEs may be a physical distance between the two AEs. For example, as shown in FIG. 5, the effective distance between the AE 502 and the AE 508 may be a straight line distance 517 between a reference point 516 of the AE 502 and a reference point 518 of the AE 508.

Alternatively, the effective distance between two AEs may be the length of a trajectory from the first AE to the second AE via portal(s) via which the two AEs are connected. In some embodiments, the trajectory may be a trajectory from a reference point in the first AE to a reference point in the second AE via the portals that connect the two AEs. The exact way in which such trajectory is defined may vary. For example, as shown in FIG. 5, the effective distance between the AE 502 and the AE 506 may be a length of a trajectory—520₁+520₂+520₃+520₄—from the AE 506 to the AE 502 via portals 522 and 524 through which the AEs 502 and 506 are connected. As shown in FIG. 5, the trajectory from the AE 506 to the AE 502 comprises a first trajectory portion 520₁ between a reference point 536 of the AE 506 and a reference point 540 of the portal 524, a second trajectory portion 520₂ between the reference point 540 of the portal 524 and a reference point 534 of the AE 504, a third trajectory portion 520₃ between the reference point 534 of the AE 504 and a reference point 550 of the portal 522 and a fourth trajectory portion 520₄ between the reference point 550 of the portal 522 and the reference point 516 of the AE 502. In other examples, the trajectory may directly connect the portals that connect the first AE to the second AE. For example, the trajectory from AE 506 to AE 502 in FIG. 5 may be defined by the combination of the trajectory portion 520₁, a trajectory portion connecting the reference point 540 of the portal 524 and the reference point 550 of the portal 522 (not shown), and the trajectory portion 520₄.

Alternatively, the effective distance between two AEs may be defined by the number of AE crossings (portals) via which the two AEs are connected to each other. Here, the effective distance is not so much about the actual physical distance but is more about the number of portals between the two AEs. For example, in FIG. 5, the effective distance between the AE 502 and the AE 504 is 1 because there is only one portal 522 between the AE 502 and the AE 504 while the effective distance between the AE 502 and the AE 506 is 2 because there are two portals 522 and 524 between the AE 502 and the AE 506.

In some embodiments, the effective distance between two AEs may further be determined based on the sizes and/or positions of the portals connecting the two AEs. Using the sizes and/or positions of the portals, it may be determined how much (e.g., what level or portion) of a connected AE's reverberation reaches the listener's AE, and this information may be used as an “effective distance” indicator. For example, in FIG. 5, the effective distance between the AE 502 and the AE 506 may be determined based on a function of the number of portals between the AE 502 and the AE 506, and/or the sizes and/or positions of the portals 522 and 524 . . . . In other words, the function ƒ may be defined as ƒ(Sizeₛₑₜ(Size₁, Size₂, . . . ), Positionₛₑₜ(Position₁, Position₂, . . . ), N) where Sizeₛₑₜ is a set of size values of portals between two AEs, Positionₛₑₜ is a set of position values of the portals between the two AEs, and N is the number of the portals between the two AEs.

In some embodiments, in addition to the effective distance, acoustic properties of the listener's AE, e.g., the listener AE's reverberation time, reverberation level and/or reverberant energy ratio, as well as the positions and levels of sound sources (e.g., in which AE's they are located), may be taken into account to determine the overall importance (e.g., relative energetic or perceptual contribution) of the reverberation of a connected AE to the listening experience of the listener in the listener's AE, and base the number of delay lines for the connected AE on this overall importance.

### Maximum Distance for Generating Reverberation

In some embodiments, there may be provided a maximum effective distance between the listener's AE and a connected AE for allowing the generation of reverberation for the connected AE. For example, in some embodiments, no reverberation may be generated for a connected AE in case the effective distance (which can be derived using any one of the methods described above) between the connected AE and the listener's AE is more than a certain maximum value. The rationale here is that if the connected AE is at more than a certain maximum effective distance away from the listener's AE, the level or portion of reverberation generated for the connected AE that would reach the listener's AE would be below a certain threshold. In such scenario, there is no need to generate reverberation for the connected space. In one example, no reverberation may be generated for a connected AE that is at least a certain number (X) of portals away from the listener AE. In another example, no reverberation may be generated for a connected AE for which the level or portion of reverberation reaching the listener's AE is below a certain threshold. This may significantly reduce the computational complexity for generating reverberation for a scene with many AEs. Also this will not likely impact the perceived audio quality for the listener in a significant way since typically the reverberation for a connected AE that is more than a few portals away from the listener's AE hardly contributes to the listener's audio experience.

Alternatively, the number of FDN delay lines for generating reverberation for a connected AE that is more than a maximum effective distance away from the listener's AE may be set to some number (e.g., the minimum number in a set of predefined values). For example, for each connected AE that is more than X portals away from the listener's AE, the number of delay lines of the corresponding FDN may set to be some minimum number. The minimum number may be defined as an overall minimum number for all AEs or it may be defined for an individual AE (e.g., taking the individual AE's acoustic properties into account).

As mentioned earlier, the number of FDN delay lines used for generating reverberation for the listener's AE (or more generally, the complexity/quality of reverberation to be generated for the listener's AE) may be determined by general or specific criteria as proposed in Reference [1] (i.e., from acoustic properties of the listener's AE and/or the number of FDN delay lines (or more general complexity/quality parameter) as specified for the listener's AE in a bitstream/config parameter). The rationale for this is that the reverberation that is generated for the listener's AE should always have a good quality, as it is listened to directly.

In some embodiments, an additional metadata or a configuration parameter for an AE may be provided to indicate whether a provided number of delay lines for that AE (e.g., provided in the bitstream or as a runtime configuration parameter) should be used by the renderer “as is” or may be altered by the renderer in order to optimize the complexity-quality trade-off. This allows the content creator to specify that the reverberation for a specific AE should always be generated using the specified number of delay lines. On one hand, these embodiments enable enforcing that the quality of the generated reverberation for an AE is not reduced when the listener moves out of the AE, thus ensuring that the reverberation always has a certain quality, which may be desirable in some use cases. On the other hand, the embodiments also enable enforcing that the quality (and thus complexity) of the generated reverberation is not increased when the listener moves into, or closer to, the AE. This may in some cases be useful to keep the computational complexity sufficiently low.

In some embodiments, the number of FDN delay lines determined according to general or specific criteria as proposed in Reference [1] (a.k.a., “nominal number of FDN delay lines”) may be interpreted as a maximum number of FDN delay lines (reverberation quality/complexity) for that AE. In other words, the maximum number of FDN delay lines for the reverberator of a specific AE can be determined by the AE's acoustic properties and/or an explicit number specified in a bitstream/config parameter. In these embodiments, in a typical use case, the maximum number of FDN delay lines would be used when the listener is in that AE, while the number of FDN delay lines would typically be chosen to be lower than that maximum value when the listener is not in that AE.

### Minimum Number of FDN Delay Lines

In some embodiments, the number of FDN delay lines (i.e., quality/complexity of the reverberation to be generated) used for generating reverberation for an AE, if active, should never be lower than a certain lower limit (e.g., 3: the lowest number of delay lines as proposed in Reference [1]).

### Maximum Allowed Total Number of FDN Delay Lines

In some embodiments, a maximum total complexity (e.g., a maximum number of FDN delay lines) allowed for generating reverberation for an XR scene may be defined. In such embodiments, the complexity/quality of reverberation generated for each AE in an XR scene must be set such that the sum of all complexities involved in generating reverberation for all AEs in an XR scene must be less than the maximum total complexity. For example, in the scenario shown in FIG. 5, if the maximum number of FDN delay lines allowed for generating reverberation in the XR scene is Nₘₐₓ, then each of the numbers of FDN delay lines for the AEs 502, 504, 506, and 508 (i.e., N₅₀₂, N₅₀₄, N₅₀₆, N₅₀₈) should be determined such that N₅₀₂+N₅₀₄+N₅₀₆+N₅₀₈≤Nₘₐₓ.

The maximum total complexity (e.g., the maximum total number of FDN delay lines) may be specified as a metadata parameter for the scene, or it may be determined by the renderer itself, e.g., based on available computational resources and/or other aspects of the scene to be rendered. As such, the maximum total complexity for reverberation may itself be a dynamic variable that depends on the total instantaneous rendering complexity for the scene (i.e., including all rendering aspects, of which reverberation is only one).

The algorithm that distributes the maximum total complexity (e.g., the maximum total number of delay lines) over the AEs may incorporate any of the aspects described above. More specifically, in one example, the maximum total complexity may be distributed over the AEs based on which AE is the listener's AE, and an effective distance between each of the connected AEs and the listener's AE. As such, the distribution of the maximum total complexity over the AEs may be dynamically changed in response to the listener's movement within the scene.

Dynamic Configuration of the Number of FDN Delay Lines (or More Generally, Quality and/or Complexity of Generated Reverberation)

As discussed above, the number of FDN delay lines used for generating reverberation for an AE may depend on whether the AE is the listener's AE or a connected AE and/or, in case the AE is not the listener's AE, a distance between the AE and the listener's AE. However, as the virtual user moves from one AE to another AE in a multi-space scene, the relationships between all connected AEs change. Specifically, the AE that was the listener's AE before the virtual user moves now becomes a connected AE while a previous connected AE that the virtual user moves to now becomes the listener's AE. Furthermore, since the listener's AE has changed, the effective distances between the listener's AE and all other AEs in the XR scene are also changed.

This implies that, as a result of the virtual user moving into another AE, the number of FDN delay lines of the AE that was previously the listener's AE before the move and the AE that becomes a new listener's AE after the move should be updated to reflect the new situation. For example, the number of FDN delay lines for the “old” listener's AE may be decreased while the number of FDN delay lines for the “new” listener's AE may be increased. The number of FDN delay lines of some or all of other connected AEs may be maintained in some embodiments, while in other embodiments, the number of FDN delay lines of some or all of other connected AEs may be updated.

For example, in those embodiments where the number of FDN delay lines for an AE depends on a distinction between whether the AE is the listener's AE and whether the AE is a connected AE, only the “old” listener's AE and the “new” listener's AE need to be updated because all other AEs remain to be the same as being the connected AEs.

In another example, in those embodiments where the number of FDN delay lines for a connected AE depends on the effective distance between the connected AE and the listener's AE, the number of FDN delay lines for some or all of other AEs may need to be updated because, as the listener's AE is changed, the effective distance between each AE and the listener's AE is changed.

In further example, in those embodiments where connected AEs that are more than a maximum distance away from the listener's AE are configured with a certain defined minimum number of FDN delay lines, only connected AEs that after the move are at less than the maximum distance from the listener's AE need to be updated. In other words, the number of FDN delay lines of the connected AEs that are still more than the maximum “distance” away from the listener's AE after the move remain unchanged.

Dynamically changing the number of FDN delay lines of some or all of the AEs when the virtual user moves into another AE may cause possible audio artefacts (e.g., clicks, sudden timbre changes, or other artefacts) at the moment that the number of FDN delay lines are updated. Thus, according to some embodiments, multiple FDNs (e.g., two FDNs) may be run simultaneously for some or all of the affected AE's, one with the “old” number of delay lines and one with the “new” number of delay lines, and then smoothly transition between the outputs of the two FDN's. Once the transition has finished, the “old” FDN can be terminated.

For example, let's assume that the number of FDN delay lines used for generating reverberation for the listener's AE is set as 31 and the number of FDN delay lines used for generating reverberation for all other connected AEs is set as 15. Then, in FIG. 5, the number of FDN delay lines used for generating reverberation for the AE 502 where the virtual user 512 is currently in is 31 while the number of FDN delay lines used for generating reverberation for each of the AEs 504, 506, and 508 is 15.

In this scenario, if the virtual user 512 leaves the AE 502 and enters the AE 508 at time t₀, during a transition time period starting at t₀, reverberation for the AE 508 may be generated using two different numbers of FDN delay lines. More specifically, during the transition period, a first FDN including 31 delay lines and a second FDN including 15 delay lines may be used for generating reverberation for the AE 508. The reverberation signals outputted from the first FDN and the reverberation signals outputted from the second FDN may be weighted-combined, and the combined signals are used for generating reverberation for the AE 508.

In some embodiments, as the time elapses during the transition period, the weight given to the reverberation signals outputted from the first FDN and the weight given to the reverberation signals outputted from the second FDN may be continuously adjusted. For example, as the time elapses during the transition period, the weight given to the reverberation signals outputted from the first FDN may gradually increase while the weight given to the reverberation signals outputted from the second FDN may gradually decrease. The rationale here is that as the AE 508 is transitioned from a connected AE to a listener's AE, the reverberation signals outputted from the first FDN that is used for generating reverberation for the listener's AE are given more weight while the reverberation signals outputted from the second FDN that is used for generating reverberation for a connected AE are given less weight.

But running multiple FDNs simultaneously may temporarily increase the overall computational complexity of the reverberation processing significantly, as there are more FDNs active during the transition period. Thus, in some embodiments, not all FDN's of all connected AE's are updated simultaneously but are instead updated sequentially according to some prioritization scheme. For example, in one embodiment initially only the FDNs of the “old” and/or “new” listener's AE are updated. Only once these FDNs have been updated, the FDNs of the other connected AEs are updated in a sequential manner, where priority may be given to connected AEs that are closest to the “new” listener's AE (in terms of number of portals or some other “distance” criterion).

### Choosing the Number of Delay Lines of an FDN

As discussed above, the number of delay lines of an FDN used for generating reverberation for the listener's AE may be derived based on a nominal number of FDN delay lines for the listener's AE which may be determined according to the general or specific criteria described in Reference [1] the disclosure of which is hereby incorporated by reference (i.e., the nominal number of delay lines for the listener's AE may be based on the acoustical properties of the listener's AE or from a provided configuration parameter which may be specific for the listener's AE or may be a general configuration parameter that applies to all AE's in the XR scene).

The number of FDN delay lines for a connected AE (i.e., an AE that is connected to the listener's AE) may be determined based on the nominal number of FDN delay lines for the connected AE. For example, like the above described way that the number of FDN delay lines for the listener's AE is derived based on the nominal number of FDN lines for the listener's AE, the number of FDN delay lines for the connected AE may be derived based on the nominal number of FDN lines for the connected AE, where the nominal number of FDN delay lines for the connected AE may be determined in the same way as for the listener's AE (e.g., based on the acoustical properties of the connected AE or from a provided configuration parameter which may be specific for the connected AE or may be a general configuration parameter that applies to all AE's in the XR scene). Alternatively, the number of FDN delay lines for the connected AE may be determined based on any other reference number of FDN delay lines (which is different from the nominal number of FDN lines). In some embodiments, there may be provided a set of preset values (e.g., 3, 7, 15, 31, 63 and 127), and one of the preset values may be selected as the number of FDN delay lines for a connected AE based on the nominal number of FDN delay lines for that connected AE (or the other reference number of FDN delay lines).

For example, in those embodiments where the number of FDN delay lines for an AE depends on a distinction between whether the AE is the listener's AE or whether the AE is a connected AE, one of the preset values, which is directly below the nominal number of FDN delay lines for a connected AE, may be selected as the number of FDN delay lines for that connected AE. For example, in case the set of preset values comprises 3, 7, 15, 31, 63 and 127, if FDNs of all AEs in an XR scene have a nominal number of 15 delay lines, then the FDN of the listener's AE would be configured with 15 delay lines while the FDNs of all connected AEs would be configured with 7 delay lines.

In those embodiments where the number of FDN delay lines for a connected AE depends on the effective distance between the connected AE and the listener's AE, a discrete scheme may be used. In these embodiments, one of the numbers included in a set of preset values (e.g., 3, 7, 15, 31, 63 and 127) may be selected as the number of FDN delay lines for the connected AE depending on the effective distance between the listener's AE and the connected AE. For example, in case the nominal number of FDN delay lines for a connected AE is 31, the number of FDN delay lines for the connected AE may be determined as follows:

| | |
|---|---|
| Outside the effective distance range 2 | 3 |
| Within an effective distance range 2 | 7 |
| Within an effective distance range 1 | 15 |

In the above example, in case the connected AE is within the effective distance range 1 from the listener's AE, the number of FDN delay lines for the connected AE may be set to be 15. On the other hand, in case the connected AE is outside the effective distance range 1 from the listener's AE but within the effective distance range 2 from the listener's AE, the number of FDN delay lines for the connected AE may be set to be 7. In case the connected AE is outside the effective distance range 2 from the listener's AE, the number of FDN delay lines for the connected AE may be set to be 3.

As explained above, in some embodiments, the effective distance may be defined based on a number of portals via which a connected AE is connected to the listener's AE. In those embodiments, one of the numbers included in the set of preset values (e.g., 3, 7, 15, 31, 63 and 127) may be selected as the number of FDN delay lines for the connected AE depending on the number of portals between the listener's AE and the connected AE.

For example, for a connected AE (e.g., the AE 504 in FIG. 5A) that is only one portal away from the listener's AE (e.g., the AE 502 in FIG. 5A), one of the numbers included in the set of preset values, which is one step below the nominal number of FDN lines for the connected AE, may be selected. More specifically, in case the nominal number of FDN lines for the AE 504 is 31, then, for the AE 504 which is only one portal away from the listener's AE 502, “15” may be selected as the number of FDN lines for the AE 504. Similarly, since the AE 506 is two portals away from the AE 502, “7” may be selected as the number of FDN lines for the AE 506.

In some embodiments, the number of FDN delay lines for a connected AE may be determined by scaling the nominal number of FDN delay lines for that AE (or a certain reference number of FDN delay lines) based on the effective distance between the connected AE and the listener's AE, and selecting a number included in the set of preset values that is closest to the scaled number. The scaling may be performed using a function (e.g., a linear function) of the number of portals between a connected AE and the listener's AE and/or of a physical distance between the connected AE and the listener's AE.

For example, the function may be

$$\frac{1}{{2}^{N}}$$

where Iv is equal to a number of portals between a connected AE and the listener's AE. In this example, if a connected AE (e.g., the AE 504) is one portal away from the listener's AE (e.g., the AE 502), the function becomes ½. Then, in case the nominal number of FDN delay lines for the AE 504 is 31, the scaling may be performed as follows: 31/2, thereby resulting in the scaling number 15.5. Here, since, among the set of preset values (3, 7, 15, 31, 63 and 127), 15 is closest to the scaled number, 15 is used as the number of FDN delay lines for the connected AE (e.g., the AE 504).

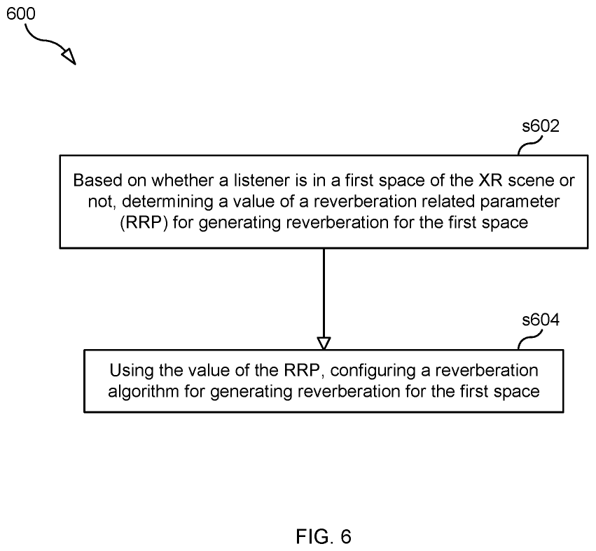

FIG. 6 shows a process 600 for enabling the rendering of reverberation in an extended reality, XR, scene according to some embodiments. The process 600 may begin with step s602. Step s602 comprises, based on whether a virtual listener is in a first space of the XR scene or not, determining a value of a reverberation related parameter, RRP, for generating reverberation associated with the first space. Step s604 comprises, using the value of the RRP, configuring (s604) a reverberation algorithm for generating reverberation associated with the first space.

In some embodiments, the value of the RRP indicates at least partially the computational complexity of the reverberation algorithm and/or the quality of the generated reverberation associated with the first space.

In some embodiments, the process 600 comprises generating at least one reverberation audio signal using the reverberation algorithm, and transmitting the generated at least one reverberation audio signal to an audio renderer or rendering audio to the listener using the generated at least one reverberation audio signal.

In some embodiments, the value of the RRP indicates a number of delay lines of a feedback delay network, FDN for generating reverberation associated with the first space.

In some embodiments, the value of the RRP is equal to a first value in case the listener is in the first space and a second value in case the listener is not in the first space, and the first value is greater than the second value.

In some embodiments, determining the value of the RRP comprises: obtaining a nominal value of the RRP, and determining the value of the RRP based on the nominal value of the RRP.

In some embodiments, obtaining the nominal value of the RRP comprises deriving the nominal value of the RRP based on one or more acoustic properties of the first space.

In some embodiments, said one or more acoustic properties of the first space includes one or more of: a reverberation time of the first space, a reverberant energy ratio of the first space, and/or a reverberation level of the first space.

In some embodiments, the value of the RRP is determined by: (i) using the nominal value as the value of the RRP, (ii) using a first value as the value of the RRP, wherein the first value is greater than the nominal value, or (iii) using a second value as the value of the RRP, wherein the second value is smaller than the nominal value.

In some embodiments, the first value is greater than the nominal value by (i) a first amount in case the listener is in the first space and (ii) a second amount in case the listener is not in the first space, and the first amount is greater than the second amount.

In some embodiments, the second value is smaller than the nominal value by (i) a first amount in case the listener is in the first space and (ii) a second amount in case the listener is not in the first space, and the second amount is greater than the first amount.

In some embodiments, determining the value of the RRP comprises: in case the listener is in the first space, using the nominal value as the value of the RRP, and in case the listener is not in the first space, using the second value as the value of the RRP.

In some embodiments, the process 600 comprises obtaining a value of a configuration parameter, wherein the value of the configuration parameter indicates whether the nominal value of the RRP should be used as it is for generating reverberation associated with the first space or whether a value that is different from the nominal value of the RRP can be used for generating reverberation associated with the first space.

In some embodiments, determining the value of the RRP comprises: obtaining a group of predefined values of the RRP, and based on whether the listener is in the first space or not, selecting one of the predefined values of the RRP.

In some embodiments, the group of the predefined values of the RRP comprises a first value and a second value, the first value is greater than the second value, selecting one of the predefined values of the RRP comprises selecting the first value in case the listener is in the first space and selecting the second value in case the listener is not in the first space.

In some embodiments, the second value is the greatest value among all values that are included in the group of the predefined values and that are smaller than the first value.

In some embodiments, the process 600 comprises determining that the listener is not in the first space; and determining an effective distance between the first space and a current listening space where the listener is, wherein the value of the RRP is determined based on the determined effective distance.

In some embodiments, the value of the RRP is equal to a first value when the effective distance is within a certain range that includes zero, the value of the RRP is equal to a value that is different from the first value when the effective distance is not within the certain range, and the first value is greater than the different value.

In some embodiments, the value of the RRP increases as the determined effective distance decreases, and the value of the RRP decreases as the determined effective distance increases.

In some embodiments, an amount of increasing the nominal value increases as the determined effective distance decreases, and the amount of increasing the nominal value decreases as the determined effective distance increases.

In some embodiments, an amount of decreasing the nominal value increases as the determined effective distance increases, and the amount of decreasing the nominal value decreases as the determined effective distance decreases.

In some embodiments, said one of the predefined values of the RRP is selected based on the effective distance.

In some embodiments, said one of the predefined values of the RRP comprises a nominal value of the RRP or is selected based on the nominal value of the RRP, and the nominal value of the RRP is for generating reverberation associated with the first space when the listener is in that space.

In some embodiments, the group of the predefined values of the RRP comprises a first predefined value of the RRP and a second predefined value of the RRP, the first predefined value of the RRP is for generating reverberation associated with the first space when the first space is within a first distance from the current listening space, the second predefined value of the RRP is for generating reverberation associated with the first space when the first space is at least the first distance away from the current listening space, the nominal value of the RRP is greater than the first predefined value of the RRP, and the first predefined value of the RRP is greater than the second predefined value of the RRP.

In some embodiments, said one of the predefined values of the RRP is selected by: using a function, determining a scaling value based on the effective distance; applying the scaling value to the nominal value of the RRP, thereby obtaining a resulting value; and determining that said one of the predefined values of the RRP is closest to the resulting value among the predefined values of the RRP.

In some embodiments, the effective distance is determined based on one or more of the followings: (i) a distance between a reference point in the first space and a reference point in the current listening space, (ii) a length of a trajectory from a reference point in the first space to a reference point in the current listening space via one or more portals through which the first space is connected to the current listening space, (iii) a number of portals in a trajectory from the first space to the current listening space, and/or (iv) a size of each of portals in a trajectory from the first space to the current listening space.

In some embodiments, the process 600 comprises comparing the effective distance value to a threshold value; determining that the effective distance value is greater than the threshold value; and as a result of determining that the effective distance value is greater than the threshold value, setting the value of the RRP to be a certain value.

In some embodiments, the XR scene comprises a plurality of spaces including the first space, and the value of the RRP for generating reverberation associated with the first space is determined such that a sum of values of the RRP each of which is for generating reverberation associated with a space included in the plurality of spaces satisfies a certain criterion.

In some embodiments, the certain criterion is being less than a predefined maximum value.

In some embodiments, the process 600 comprises (i) determining that the listener is in the first space; (ii) based on determining that the listener is in the first space, for each space included in a first subset of spaces included in the XR scene, determining a value of the RRP for generating reverberation associated with the respective space; (iii) after determining that the listener is in the first space, determining that the listener is now in the second space; and (iv) based on determining that the listener is in the second space, for each space included in a second subset of spaces included in the XR scene, determining a value of the RRP for generating reverberation associated with the respective space, wherein the first and second sets of spaces overlap at least partially.

In some embodiments, during step (ii) of paragraph [0127], for each respective space included in the first subset of spaces included in the XR scene, the value of the RRP for generating reverberation associated with the respective space is determined based on a first effective distance between the respective space in the first subset and the first space, and during step (iv) of paragraph [0127], for each space included in the second subset of spaces included in the XR scene, the value of the RRP for generating reverberation associated with the respective space is determined based on a second effective distance between the respective space in the second subset and the second space.

In some embodiments, the first effective distance is determined based on one or more of the followings: (i) a distance between a reference point in the first space and a reference point in the respective space included in the first subset, (ii) a length of a trajectory from a reference point in the first space to a reference point in the respective space included in the first subset via one or more portals through which the first space is connected to the respective space included in the first subset, (iii) a number of portals in a trajectory from the first space to the respective space included in the first subset, and/or (iv) a size of each of portals in a trajectory from the first space to the respective space included in the first subset.

In some embodiments, the second effective distance is determined based on one or more of the followings: (i) a distance between a reference point in the second space and a reference point in the respective space included in the second subset, (ii) a length of a trajectory from a reference point in the second space to a reference point in the respective space included in the second subset via one or more portals through which the second space is connected to the respective space included in the second subset, (iii) a number of portals in a trajectory from the second space to the respective space included in the second subset, and/or (iv) a size of each of portals in a trajectory from the second space to the respective space included in the second subset.

In some embodiments, during step (ii) of paragraph [0127], a first value of the RRP for generating reverberation associated with the second space is determined based on determining that the listener is in the first space, during step (iv) of paragraph [0127], a second value of the RRP for generating reverberation associated with the second space is determined based on determining that the listener is in the second space, the second value is higher than the first value, and the process 600 comprises generating reverberation associated with the second space using both the first value of the RRP and the second value of the RRP during a certain transition period after the listener has moved from the first space to the second space.

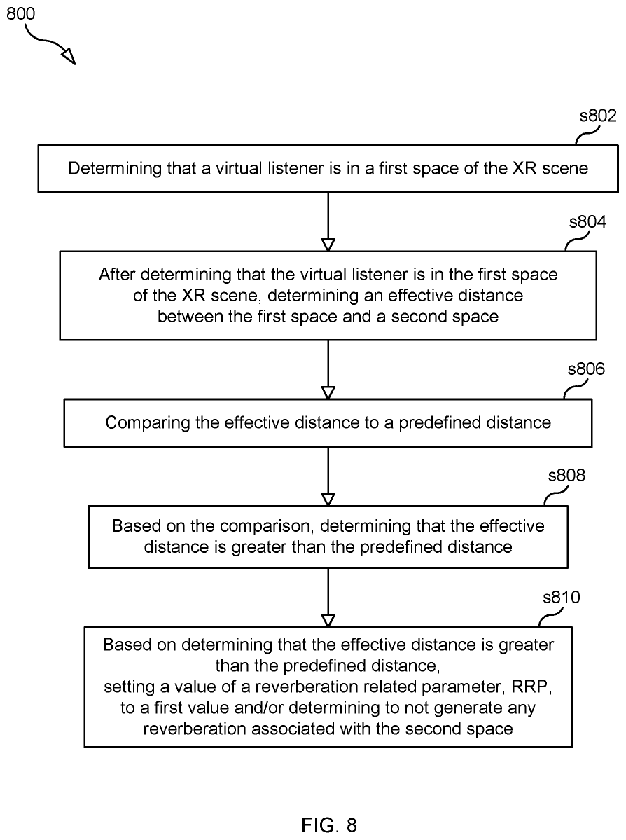

FIG. 8 shows a process 800 for enabling the rendering of reverberation in an extended reality, XR, scene according to some embodiments. The process 800 may begin with step s802. Step s802 comprises determining that a virtual listener is in a first space of the XR scene. Step s804 comprises, after determining that the virtual listener is in the first space of the XR scene, determining an effective distance between the first space and a second space. Step s806 comprises comparing the effective distance to a predefined distance. Step s808 comprises, based on the comparison, determining that the effective distance is greater than the predefined distance. Step s810 comprises, based on determining that the effective distance is greater than the predefined distance, setting a value of a reverberation related parameter, RRP, to a first value and/or determining to not generate any reverberation associated with the second space. The RRP is for generating reverberation associated with the second space.

In some embodiments, the effective distance between the first space and the second space is determined based on one or more of the followings: (i) a distance between a reference point in the first space and a reference point in the second space, (ii) a length of a trajectory from a reference point in the first space to a reference point in the second space via one or more portals through which the first space is connected to the second space, (iii) a number of portals in a trajectory from the first space to the second space, and/or (iv) a size of each of portals in a trajectory from the first space to the second space.

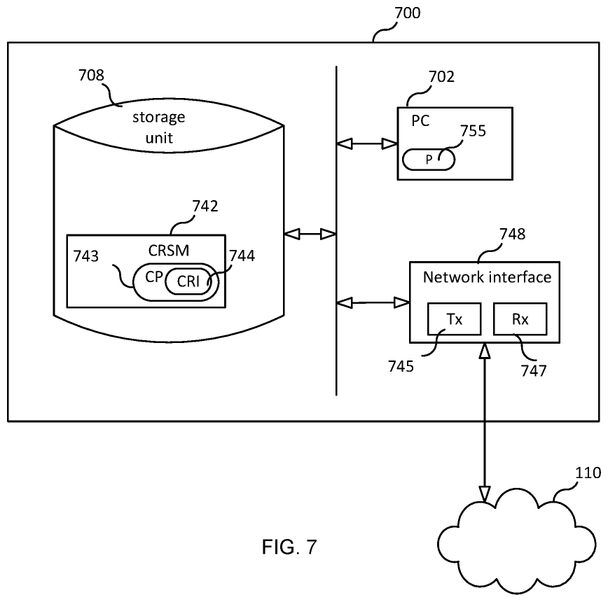

FIG. 7 is a block diagram of an apparatus 700, according to some embodiments, for performing the methods disclosed herein. That is, apparatus 700 may implement audio renderer 251 or encoder 269. Apparatus 700 may be referred to as an audio rendering apparatus when apparatus 700 implements an audio renderer and apparatus 700 may be referred to as an encoding apparatus when apparatus 700 implements an encoder. As shown in FIG. 7, apparatus 700 may comprise: processing circuitry (PC) 702, which may include one or more processors (P) 755 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 700 may be a distributed computing apparatus); at least one network interface 748 comprising a transmitter (Tx) 745 and a receiver (Rx) 747 for enabling apparatus 700 to transmit data to and receive data from other nodes connected to a network 110 (e.g., an Internet Protocol (IP) network) to which network interface 748 is connected (directly or indirectly) (e.g., network interface 748 may be wirelessly connected to the network 110, in which case network interface 748 is connected to an antenna arrangement); and a storage unit (a.k.a., “data storage system”) 708, which may include one or more non-volatile storage devices and/or one or more volatile storage devices. In embodiments where PC 702 includes a programmable processor, a computer program product (CPP) 741 may be provided. CPP 741 includes a computer readable medium (CRM) 742 storing a computer program (CP) 743 comprising computer readable instructions (CRI) 744. CRM 742 may be a non-transitory computer readable medium, such as, magnetic media (e.g., a hard disk), optical media, memory devices (e.g., random access memory, flash memory), and the like. In some embodiments, the CRI 744 of computer program 743 is configured such that when executed by PC 702, the CRI causes apparatus 700 to perform steps described herein (e.g., steps described herein with reference to the flow charts). In other embodiments, apparatus 700 may be configured to perform steps described herein without the need for code. That is, for example, PC 702 may consist merely of one or more ASICs. Hence, the features of the embodiments described herein may be implemented in hardware and/or software.

### REFERENCE LIST

| | |
|---|---|
| 1. | ISO/IEC JTC1/SC29/WG6 M63041, “CE on flexible number of |
| | delay lines for reverb”, input contribution to 142^{nd} MPEG/11^{th} |
| | WG6 meeting, April 2023. |
| 2. | ISO/IEC JTC1/SC29/WG6 N00181, ‘WD2 of ISO/IEC 23090-4, |
| | MPEG-I Immersive Audio’, MPEG 141, January 2023. |

### SUMMARY OF EMBODIMENTS

A1. A method (600) for enabling the rendering of reverberation in an extended reality, XR, scene, the method comprising:
based on whether a listener is in a first space of the XR scene or not, determining (s602) a value of a reverberation related parameter, RRP, for generating reverberation for the first space; and
using the value of the RRP, configuring (s604) a reverberation algorithm for generating reverberation for the first space.

A2. The method of embodiment A1, wherein the value of the RRP indicates at least partially the computational complexity of the reverberation algorithm and/or the quality of the generated reverberation for the first space.

A3. The method of at least one of embodiments A1 and A2, the method comprising:
generating at least one reverberation audio signal using the reverberation algorithm, and
transmitting the generated at least one reverberation audio signal to an audio renderer or rendering audio to the listener using the generated at least one reverberation audio signal.

A4. The method of at least one of embodiments A1-A3, wherein the value of the RRP indicates a number of delay lines of a feedback delay network, FDN for generating reverberation for the first space.

A5. The method of at least one of embodiments A1-A4, wherein
the value of the RRP is equal to a first value in case the listener is in the first space and a second value in case the listener is not in the first space, and
the first value is greater than the second value.

A6. The method of at least one of embodiments A1-A5, wherein determining the value of the RRP comprises:
obtaining a nominal value of the RRP (e.g., receiving it via a bitstream), and
determining the value of the RRP based on the nominal value of the RRP.

A7. The method of embodiment A6, wherein obtaining the nominal value of the RRP comprises deriving the nominal value of the RRP based on one or more acoustic properties of the first space.

A8. The method of embodiment A7, wherein said one or more acoustic properties of the first space includes one or more of: a reverberation time of the first space, a reverberant energy ratio of the first space, and/or a reverberation level of the first space.

A9. The method of at least one of embodiments A6-A8, wherein the value of the RRP is determined by performing one of:
(i) using the nominal value as the value of the RRP,
(ii) increasing the nominal value, and using the increased nominal value as the value of the RRP, or
(iii) decreasing the nominal value, and using the decreased nominal value as the value of the RRP.

A10. The method of embodiment A9, wherein
increasing the nominal value comprises (i) increasing the nominal value by a first amount in case the listener is in the first space and (ii) increasing the nominal value by a second amount in case the listener is not in the first space, and
the first amount is greater than the second amount.

A11. The method of embodiment A9, wherein
decreasing the nominal value comprises (i) decreasing the nominal value by a first amount in case the listener is in the first space and (ii) decreasing the nominal value by a second amount in case the listener is not in the first space, and
the second amount is greater than the first amount.

A12. The method of embodiment A9, wherein determining the value of the RRP comprises:
in case the listener is in the first space, using the nominal value as the value of the RRP, and
in case the listener is not in the first space, decreasing the nominal value, and using the decreased nominal value as the value of the RRP.

A13. The method of at least one of embodiments A6-A12, the method comprising:
obtaining a value of a configuration parameter, wherein
the value of the configuration parameter indicates whether the nominal value of the RRP should be used as it is for generating reverberation for the first space or whether the nominal value of the RRP can be modified for generating reverberation for the first space.

A14. The method of at least one of embodiments A1-A13, wherein determining the value of the RRP comprises:
obtaining a group of predefined values of the RRP, and
based on whether the listener is in the first space or not, selecting one of the predefined values of the RRP.

A15. The method of embodiment A14, wherein
the group of the predefined values of the RRP comprises a first value and a second value,
the first value is greater than the second value,
selecting one of the predefined values of the RRP comprises selecting the first value in case the listener is in the first space and selecting the second value in case the listener is not in the first space.

A16. The method of embodiment A15, wherein the second value is the greatest value among all values that are included in the group of the predefined values and that are smaller than the first value.

A17. The method of at least one of embodiments A1-A16, the method comprising:
determining that the listener is not in the first space; and
determining an effective distance between the first space and a current listening space where the listener is, wherein
the value of the RRP is determined based on the determined effective distance.

A18. The method of embodiment A17, wherein
the value of the RRP is equal to a first value when the effective distance is within a certain range that includes zero,
the value of the RRP is equal to a value that is different from the first value when the effective distance is not within the certain range, and
the first value is greater than the different value.

A19. The method of at least one of embodiments A17 and A18, wherein
the value of the RRP increases as the determined effective distance decreases, and
the value of the RRP decreases as the determined effective distance increases.

A20. The method of at least one of embodiments A17-A19 (when embodiment A17 depends on embodiment A10), wherein
an amount of increasing the nominal value increases as the determined effective distance decreases, and
the amount of increasing the nominal value decreases as the determined effective distance increases.

A21. The method of at least one of embodiments A17-A19 (when embodiment A17 depends on embodiment A11), wherein
an amount of decreasing the nominal value increases as the determined effective distance increases, and
the amount of decreasing the nominal value decreases as the determined effective distance decreases.

A22. The method of at least one of embodiments A17-A19 (when embodiment A17 depends on any one of embodiments A14-16), wherein said one of the predefined values of the RRP is selected based on the effective distance.

A23. The method of embodiment A22, wherein
said one of the predefined values of the RRP comprises a nominal value of the RRP or is selected based on the nominal value of the RRP, and
the nominal value of the RRP is for generating reverberation for a space where the listener is in.

A24. The method of embodiment A23, wherein
said one of the predefined values of the RRP comprises a first predefined value of the RRP and a second predefined value of the RRP,
the first predefined value of the RRP is for generating reverberation for a space that is within a first distance from the space where the listener is in,
the second predefined value of the RRP is for generating reverberation for a space that is at least the first distance away from the space where the listener is in,
the nominal value of the RRP is greater than the first predefined value of the RRP, and
the first predefined value of the RRP is greater than the second predefined value of the RRP.

A25. The method of embodiment A23, wherein said one of the predefined values of the RRP is selected by:
using a function, determining a scaling value based on the effective distance;
applying the scaling value to the nominal value of the RRP, thereby obtaining a resulting value; and
determining that said one of the predefined values of the RRP is closest to the resulting value among the predefined values of the RRP.

A26. The method of at least one of embodiments A17-A25, wherein the effective distance is determined based on one or more of the followings:
(i) a distance between a reference point in the first space and a reference point in the current listening space,
(ii) a length of a trajectory from a reference point in the first space to a reference point in the current listening space via one or more portals through which the first space is connected to the current listening space,
(iii) a number of portals in a trajectory from the first space to the current listening space, and/or
(iv) a size of each of portals in a trajectory from the first space to the current listening space.

A27. The method of at least one of embodiments A17-A26, comprising:
comparing the effective distance value to a threshold value;
determining that the effective distance value is greater than the threshold value; and
as a result of determining that the effective distance value is greater than the threshold value, setting the value of the RRP to be a certain value.

A28. The method of at least one of embodiments A1-A27, wherein
the XR scene comprises a plurality of spaces including the first space, and
the value of the RRP for generating reverberation for the first space is determined such that a sum of values of the RRP for generating reverberation for the plurality of spaces satisfies a certain criterion (e.g., being less than a maximum number).

A29. The method of at least one of embodiments A1-A28, the method comprising:
(i) determining that the listener is in the first space;
(ii) based on determining that the listener is in the first space, determining values of the RRP for generating reverberation for a first subset of spaces included in the XR scene;
(iii) after determining that the listener is in the first space, determining that the listener is now in the second space; and
(iv) based on determining that the listener is in the second space, determining values of the RRP for generating reverberation for a second subset of spaces included in the XR scene, wherein
the first and second sets of spaces overlap at least partially.

A30. The method of embodiment A29, wherein
during step (ii) of embodiment A20, each of the values of the RRP for generating reverberation for the first subset of spaces is determined based on a first effective distance between a space included in the first subset and the first space, and
during step (iv) of embodiment A20, each of the values of the RRP for generating reverberation for the second subset of spaces is determined based on a second effective distance between a space included in the second subset and the second space.

A31. The method of embodiment A30, wherein the first effective distance is determined based on one or more of the followings:
(i) a distance between a reference point in the first space and a reference point in a space included in the first subset,
(ii) a length of a trajectory from a reference point in the first space to a reference point in the space included in the first subset via one or more portals through which the first space is connected to the space included in the first subset,
(iii) a number of portals in a trajectory from the first space to the space included in the first subset, and/or
(iv) a size of each of portals in a trajectory from the first space to the space included in the first subset.

A32. The method of embodiment A31, wherein the second effective distance is determined based on one or more of the followings:
(i) a distance between a reference point in the second space and a reference point in a space included in the second subset,
(ii) a length of a trajectory from a reference point in the second space to a reference point in the space included in the second subset via one or more portals through which the second space is connected to the space included in the second subset,
(iii) a number of portals in a trajectory from the second space to the space included in the second subset, and/or
(iv) a size of each of portals in a trajectory from the second space to the space included in the second subset.

A33. The method of at least one of embodiments A29-A32, wherein
determining the values of the RRP for generating reverberation for the first subset comprises determining a first value of the RRP for generating reverberation for the second space based on determining that the listener is in the first space,
determining the values of the RRP for generating reverberation for the second subset comprises determining a second value of the RRP for generating reverberation for the second space based on determining that the listener is in the second space,
the second value is higher than the first value, and
the method comprises generating reverberation for the second space using both the first value of the RRP and the second value of the RRP during a certain transition period after the listener has moved from the first space to the second space.

B1. A computer program (700) comprising instructions (744) which when executed by processing circuitry (702) cause the processing circuitry to perform the method of at least one of embodiments A1-A33.

B2. A carrier containing the computer program of embodiment B1, wherein the carrier is one of an electronic signal, an optical signal, a radio signal, and a computer readable storage medium.

C1. An apparatus (700) for enabling the rendering of reverberation in an extended reality, XR, scene, the apparatus being configured to:
based on whether a listener is in a first space of the XR scene or not, determine (s602) a value of a reverberation related parameter, RRP, for generating reverberation for the first space; and
using the value of the RRP, configure (s604) a reverberation algorithm for generating reverberation for the first space.

C2. The apparatus of embodiment C1, wherein the apparatus is further configured to perform the method of at least one of embodiments A2-A33.

D1. An apparatus (700) comprising:
a processing circuitry (702); and
a memory (741), said memory containing instructions executable by said processing circuitry, whereby the apparatus is operative to perform the method of at least one of embodiments A1-A33.

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for enabling the rendering of reverberation in an extended reality (XR) scene, the method comprising:
based on whether a virtual listener is in a first space of the XR scene or not, determining a value of a reverberation related parameter (RRP) for generating reverberation associated with the first space; and
using the value of the RRP, configuring a reverberation algorithm for generating reverberation associated with the first space.

2. (canceled)

3. The method of claim 1, the method comprising:
generating at least one reverberation audio signal using the reverberation algorithm, and
transmitting the generated at least one reverberation audio signal to an audio renderer or rendering audio to the listener using the generated at least one reverberation audio signal.

4. The method of claim 1, wherein the value of the RRP indicates a number of delay lines of a feedback delay network, FDN for generating reverberation associated with the first space.

5. The method of claim 1, wherein
the value of the RRP is equal to a first value in case the listener is in the first space and a second value in case the listener is not in the first space, and
the first value is greater than the second value.

6. The method of claim 1, wherein determining the value of the RRP comprises:
obtaining a nominal value of the RRP, and
determining the value of the RRP based on the nominal value of the RRP.

7. The method of claim 6, wherein obtaining the nominal value of the RRP comprises deriving the nominal value of the RRP based on at least a first acoustic property of the first space.

8. The method of claim 7, wherein the first acoustic property is: a reverberation time of the first space, a reverberant energy ratio of the first space, or a reverberation level of the first space.

9. The method of claim 6, wherein the value of the RRP is determined by:
(i) using the nominal value as the value of the RRP,
(ii) using a first value as the value of the RRP, wherein the first value is greater than the nominal value, or
(iii) using a second value as the value of the RRP, wherein the second value is smaller than the nominal value.

10-11. (canceled)

12. The method of claim 9, wherein determining the value of the RRP comprises:
using the nominal value as the value of the RRP when the listener is in the first space, and
using the second value as the value of the RRP when the listener is not in the first space.

13. (canceled)

14. The method of claim 1, wherein determining the value of the RRP comprises:
obtaining a group of predefined values of the RRP, and
based on whether the listener is in the first space or not, selecting one of the predefined values of the RRP.

15. The method of claim 14, wherein
the group of the predefined values of the RRP comprises a first value and a second value,
the first value is greater than the second value, and
selecting one of the predefined values of the RRP comprises selecting the first value when the listener is in the first space and selecting the second value when the listener is not in the first space.

16. (canceled)

17. The method of claim 1, the method comprising:
determining that the listener is not in the first space; and
determining an effective distance between the first space and a current listening space where the listener is, wherein
the value of the RRP is determined based on the determined effective distance.

18. The method of claim 17, wherein
the value of the RRP is equal to a first value when the effective distance is within a certain range that includes zero,
the value of the RRP is equal to a second value when the effective distance is not within the certain range, and
the first value is greater than the second value.

19. The method of claim 17, wherein
the value of the RRP increases as the determined effective distance decreases, and
the value of the RRP decreases as the determined effective distance increases.

20-21. (canceled)

22. The method claim 17, wherein
determining the value of the RRP comprises:
obtaining a group of predefined values of the RRP, and
based on whether the listener is in the first space or not, selecting one of the predefined values of the RRP, and
the one of the predefined values of the RRP is selected based on the effective distance.

23. The method of claim 22, wherein
the one of the predefined values of the RRP comprises a nominal value of the RRP or is selected based on the nominal value of the RRP, and
the nominal value of the RRP is for generating reverberation associated with the first space when the listener is in that space.

24. The method of claim 23, wherein
the group of the predefined values of the RRP comprises a first predefined value of the RRP and a second predefined value of the RRP,
the first predefined value of the RRP is for generating reverberation associated with the first space when the first space is within a first distance from the current listening space,
the second predefined value of the RRP is for generating reverberation associated with the first space when the first space is at least the first distance away from the current listening space,
the nominal value of the RRP is greater than the first predefined value of the RRP, and
the first predefined value of the RRP is greater than the second predefined value of the RRP.

25. The method of claim 23, wherein the one of the predefined values of the RRP is selected by:
using a function, determining a scaling value based on the effective distance;
applying the scaling value to the nominal value of the RRP, thereby obtaining a resulting value; and
determining that the one of the predefined values of the RRP is closest to the resulting value among the predefined values of the RRP.

26. The method of claim 17, wherein the effective distance is determined based on one or more of the followings:
(i) a distance between a reference point in the first space and a reference point in the current listening space,
(ii) a length of a trajectory from a reference point in the first space to a reference point in the current listening space via one or more portals through which the first space is connected to the current listening space,
(iii) a number of portals in a trajectory from the first space to the current listening space, and/or
(iv) a size of each of portals in a trajectory from the first space to the current listening space.

27. The method of claim 17, further comprising:
comparing the effective distance value to a threshold value;
determining that the effective distance value is greater than the threshold value; and
as a result of determining that the effective distance value is greater than the threshold value, setting the value of the RRP to be a certain value.

28. The method of claim 1, wherein
the XR scene comprises a plurality of spaces including the first space, and
the value of the RRP for generating reverberation associated with the first space is determined such that a sum of values of the RRP each of which is for generating reverberation associated with a space included in the plurality of spaces satisfies a certain criterion.

29. The method of claim 28, wherein the certain criterion is being less than a predefined maximum value.

30. The method of claim 1, the method comprising:
(i) determining that the listener is in the first space;
(ii) based on determining that the listener is in the first space, for each space included in a first subset of spaces included in the XR scene, determining a value of the RRP for generating reverberation associated with the respective space;
(iii) after determining that the listener is in the first space, determining that the listener is now in the second space; and
(iv) based on determining that the listener is in the second space, for each space included in a second subset of spaces included in the XR scene, determining a value of the RRP for generating reverberation associated with the respective space, wherein
the first and second sets of spaces overlap at least partially.

31. The method of claim 30, wherein
for each respective space included in the first subset of spaces included in the XR scene, the value of the RRP for generating reverberation associated with the respective space is determined based on a first effective distance between the respective space in the first subset and the first space, and
for each space included in the second subset of spaces included in the XR scene, the value of the RRP for generating reverberation associated with the respective space is determined based on a second effective distance between the respective space in the second subset and the second space.

32-33. (canceled)

34. The method of claim 30, wherein
a first value of the RRP for generating reverberation associated with the second space is determined based on determining that the listener is in the first space,
a second value of the RRP for generating reverberation associated with the second space is determined based on determining that the listener is in the second space,
the second value is higher than the first value, and
the method comprises generating reverberation associated with the second space using both the first value of the RRP and the second value of the RRP during a certain transition period after the listener has moved from the first space to the second space.

35-38. (canceled)

39. An apparatus for enabling the rendering of reverberation in an extended reality (XR) scene, the apparatus being configured to:
based on whether a listener is in a first space of the XR scene or not, determine a value of a reverberation related parameter (RRP) for generating reverberation for the first space; and
using the value of the RRP, configure a reverberation algorithm for generating reverberation for the first space.

40-43. (canceled)
